(19) United States
(12) Patent Application Publication
(10) Pub. No.: US 2016/0330486 A1
(43) Pub. Date: Nov. 10, 2016

(54) METHOD AND APPARATUS FOR PROCESSING VIDEO SIGNAL FOR REDUCING VISIBILITY OF BLOCKING ARTIFACTS

(71) Applicant: LG ELECTRONICS INC., Seoul (KR)

(72) Inventor: Amir SAID, Cupertino, CA (US)

(21) Appl. No.: 15/107,856

(22) PCT Filed: Dec. 29, 2014
(86) PCT No.: PCT/KR2014/012952

§ 371 Date: Jun. 23, 2016

Related U.S. Application Data
(60) Provisional application No. 61/922,858, filed on Jan. 1, 2014.

(51) Int. Cl. H04N 19/86; H04N 19/70

(52) U.S. Cl. CPC H04N 19/86; H04N 19/70

(57) ABSTRACT

Disclosed herein is a method of processing a video signal, comprising: receiving a video signal comprising an original frame; generating random shift information being used to derive a relative position of the original frame; copying the original frame within an extended frame using the generated random shift information; and encoding the extended frame and the random shift information, wherein a boundary of frames included in the video signal varies for each frame based on the random shift information.

### TECHNICAL FIELD

The present invention relates to a method and apparatus for processing a video signal and, more particularly, to a technology for reducing the visibility of blocking artifacts.

### BACKGROUND ART

Video compression is an application that requires computation, but needs to be supported within a cheap consumer device. Accordingly, in order to maintain computation complexity of a manageable level, some steps for video coding independently operate on a set of pixels grouped within relatively small square blocks. Such an approach has been adopted in existing codecs and continues to be used.

Such coding, however, is disadvantageous in that discontinuity, that is, a so-called blocking artifact, is generated when reconstruction is performed in neighboring blocks. Such an artifact tends to be seen by an eye, thereby significantly reducing the subjective picture quality of a reconstructed video.

The visibility of artifacts may be reduced through a deblocking filter, but a new artifact that may not be fully removed tends to be generated in a need for more bandwidths. For example, excessive filtering reduces resolution and obviates details. Furthermore, such a new artifact is still seen visually, thereby reducing reconstruction quality.

### DISCLOSURE

### Technical Problem

There is a problem in that the subjective picture quality of a reconstructed video is significantly reduced because blocking artifacts are generated when reconstruction is performed in neighboring blocks.

There is a problem in that a new artifact is generated when deblocking filtering is performed.

There are problems in that excessive filtering reduces resolution and obviates the details of an image.

### Technical Solution

An embodiment of the present invention provides a method of reducing the visibility of blocking artifacts.

Furthermore, an embodiment of the present invention provides a method of extending a frame using random shift information.

Furthermore, an embodiment of the present invention proposes a method of obtaining a target frame from an extended frame using random shift information.

Furthermore, an embodiment of the present invention provides a method of coding and sending random shift information.

Furthermore, an embodiment of the present invention provides a method of improving the subjective picture quality of a video signal.

### Advantageous Effects

In accordance with the present invention, the visibility of blocking artifacts can be reduced by extending a frame using random shift information and obtaining a target frame from the extended frame. Furthermore, the subjective picture quality of a video signal can be improved by reducing the visibility of blocking artifacts.

Furthermore, the visibility of blocking artifacts can be reduced by making blocking artifacts appear at different positions of a target frame obtained from an extended frame.

Furthermore, in accordance with the present invention, the picture quality of a video signal can be improved using a simple method and very low costs, and more improved picture quality can be obtained at a low bit rate.

### DESCRIPTION OF DRAWINGS

FIGS. 1 and 2 illustrate schematic block diagrams of video signal processing apparatuses respectively including an encoder and decoder in accordance with embodiments to which the present invention is applied;

FIG. 3 illustrates the block structure of extended frames having fixed block boundaries in accordance with an embodiment to which the present invention is applied;

FIG. 4 illustrates the block structure of extended frames having block boundaries changed by random shift information in accordance with an embodiment to which the present invention is applied;

FIG. 5 illustrates block structures for performing a comparison between extended frames based on different pieces of random shift information in accordance with an embodiment to which the present invention is applied;

FIG. 6 illustrates block structures for performing a comparison between the vertical block boundaries of extended frames based on different pieces of random shift information in accordance with an embodiment to which the present invention is applied;

FIG. 7 illustrates block structures for performing a comparison between the horizontal block boundaries of extended frames based on different pieces of random shift information in accordance with an embodiment to which the present invention is applied;

FIG. 8 is a flowchart illustrating a process of processing a video signal using random shift information in accordance with an embodiment to which the present invention is applied;

FIG. 9 illustrates test images for comparing an image (a) coded using an existing method with an image (b) to which an embodiment of the present invention has been applied; and

FIGS. 10 to 13 are schematic block diagrams of an encoder and a decoder for processing a video signal based on an extended frame using random shift information in accordance with embodiments to which the present invention is applied.

### BEST MODE

In accordance with an aspect of the present invention, there is provided a method of processing a video signal, including receiving a video signal including the original frame, generating random shift information being used to derive a relative position of the original frame, copying the original frame within an extended frame using the generated random shift information, and encoding the extended frame and the random shift information. The boundary of frames included in the video signal varies for each frame based on the random shift information.

The random shift information is generated horizontally and/or vertically for each frame.

The extended frame is extended by one block size or more in each dimension of the original frame.

The random shift information is inserted in a slice header.

In accordance with another aspect of the present invention, there is provided a method of processing a video signal, including receiving the video signal including an extended frame and random shift information, decoding the extended frame including a target frame and the random shift information, and outputting the extended frame and the random shift information. The target frame indicates a frame with an original frame size which is cropped from the extended frame based on the random shift information.

The random shift information is used to derive the position of the target frame horizontally and/or vertically.

The extended frame has been extended by one block size or more in each dimension of the target frame.

The random shift information is extracted from the slice header of the video signal.

In accordance with yet another aspect of the present invention, there is provided an apparatus for processing a video signal, including a frame extension unit configured to receive a video signal including the original frame, generate random shift information being used to derive a relative position of the original frame, and copy the original frame within an extended frame using the generated random shift information and an encoder configured to encode the extended frame and the random shift information. The boundary of frames included in the video signal varies for each frame based on the random shift information.

The random shift information is generated horizontally and/or vertically for each frame.

The extended frame is extended by one block size or more in each dimension of the original frame.

The random shift information is inserted in a slice header.

In still yet another aspect of the present invention, there is provided a decoder for decoding a video signal, wherein the decoder configured to receive the video signal including an extended frame and random shift information, decode the extended frame including a target frame and the random shift information, and output the extended frame and the random shift information. The target frame indicates a frame with an original frame size which is cropped from the extended frame based on the random shift information.

The random shift information is used to derive the position of the target frame horizontally and/or vertically.

The extended frame has been extended by one block size or more in each dimension of the target frame.

The random shift information is extracted from the slice header of the video signal.

### MODE FOR INVENTION

Hereinafter, exemplary elements and operations in accordance with embodiments of the present invention are described with reference to the accompanying drawings. It is however to be noted that the elements and operations of the present invention described with reference to the drawings are provided as only embodiments and the technical spirit and kernel configuration and operation of the present invention are not limited thereto.

Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analysis if such terms having similar meanings are present. For example, a signal, data, a sample, a picture, a frame, and a block may be properly replaced and interpreted in each coding process.

A basic problem in removing a blocking artifact is that an artifact generated after the blocking artifact is removed is easily recognized because it remains still with respect to an image including a moving object. Accordingly, an embodiment of the present invention proposes a technology capable of removing an artifact that remains still along with an increase in negligible complexity, in particular, a technology that makes an artifact unseen in a higher frame rate.

Furthermore, new video content requires an increase of a video frame rate according to higher resolution. Some new movies are produced with 48 frames/second, and some pieces of TV are recorded with 60 frames/second. Content having such a frame rate is reaching the visibility response limit of the human sight. In order to view such a content image with higher picture quality, the present invention proposes various embodiments.

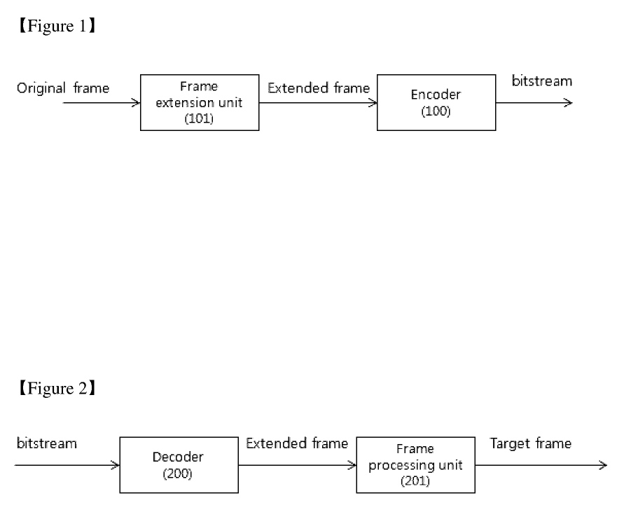

FIGS. 1 and 2 illustrate schematic block diagrams of video signal processing apparatuses respectively including an encoder and decoder in accordance with embodiments to which the present invention is applied.

Referring to FIG. 1, the video signal processing apparatus to which an embodiment of the present invention is applied may include a frame extension unit 101 and an encoder 100.

The frame extension unit 101 may receive a video signal including the original frame. The frame extension unit 101 may generate an extended frame by extending the original frame. In this case, shift information for extending the original frame may be used.

The shift information may mean used to obtain the relative position of a target frame and may include horizontal shift information and vertical shift information. Furthermore, the shift information may be randomly generated for each frame, which is hereinafter called random shift information.

The target frame may mean a frame to be finally output by the video signal processing apparatus. Alternatively, the target frame may mean a frame cropped from the extended frame.

The encoder 100 may receive an extended frame and shift information from the frame extension unit 101. Furthermore, the encoder 100 may encode the received extended frame and shift information and output the encoded extended frame and shift information.

Referring to FIG. 2, the video signal processing apparatus to which an embodiment of the present invention is applied may include a decoder 200 and a frame processing unit 201.

The decoder 200 may receive a bit stream including an extended frame and shift information. The decoder 200 may decode the extended frame and the shift information and send the decoded extended frame and shift information to the frame processing unit 201.

The frame processing unit 201 may obtain a target frame from the extended frame using the shift information. The target frame may be obtained by cropping the extended frame by the shift information.

Each target frame may be obtained based on each piece of shift information. Accordingly, each target frame may have a different block boundary.

The visibility of blocking artifacts can be reduced by continuously outputting frames having different block boundaries as described above.

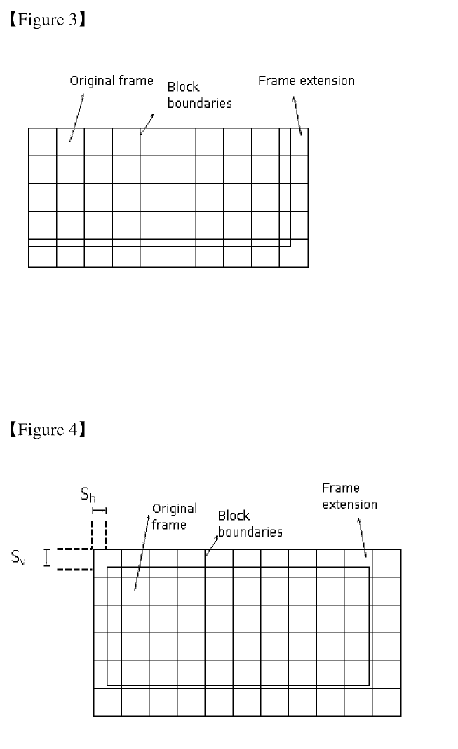

FIG. 3 illustrates the block structure of extended frames having fixed block boundaries in accordance with an embodiment to which the present invention is applied.

Referring to FIG. 3, a white region denotes the original frame, and an oblique region denotes a frame extension region. In FIG. 3, an extended frame may have a fixed block boundary like the block boundary of the original frame. That is, the block boundary of the extended frame is the same as the block boundary of the original frame.

Accordingly, although coding is performed based on an extended frame, the visibility of block artifacts may not be reduced because the extended frame has a fixed block boundary. In order to improve such a problem, an extended frame having a different block boundary in each frame needs to be used.

FIG. 4 illustrates the block structure of extended frames having block boundaries changed by random shift information in accordance with an embodiment to which the present invention is applied.

Referring to FIG. 4, a white region denotes the original frame, and an oblique region denotes a frame extension region. An extended frame to which an embodiment of the present invention is applied may be extended by a block size of at least one or more in each dimension. For example, the extended frame may be extended by shift information that has been randomly determined horizontally and/or vertically. That is, when the original frame is copied to a frame buffer, separate random shift information may be used in each frame.

Referring to FIG. 4, the extended frame has been vertically extended by Sᵥ and horizontally extended by Sₕ from the original frame. Accordingly, the original frame has a block boundary shifted by the shift information.

If each frame is extended by separate random shift information based on such a principle, the frame has a different block boundary. As a result, if the frame is recovered, the visibility of a block artifact can be reduced because different block boundaries are output at the same position.

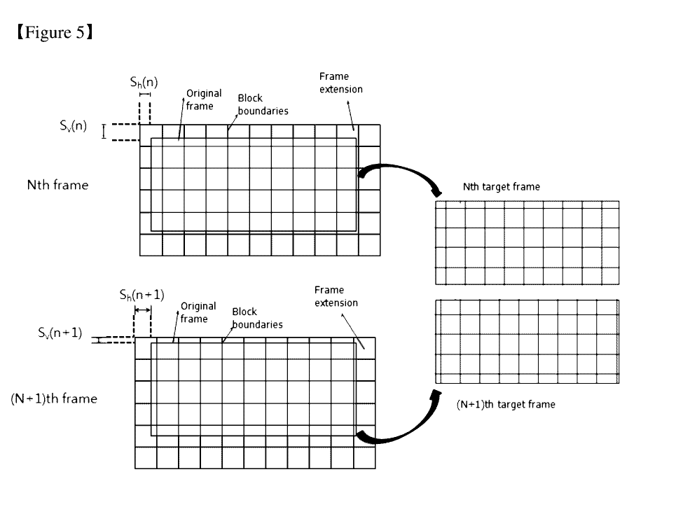

Embodiments in which target frames having vertically and horizontally different block boundaries using different pieces of random shift information in respective frames are compared with each other are described below with reference to FIGS. 5 to 7.

FIG. 5 illustrates block structures for performing a comparison between extended frames based on different pieces of random shift information in accordance with an embodiment to which the present invention is applied.

Referring to FIG. 5, a white region denotes the original frame, and an oblique region denotes a frame extension region. A case in which different pieces of shift information have been applied to an N^{th} frame and an (N+1)^{th} frame is described with reference to FIG. 5.

First, an N^{th} extended frame has been vertically extended by Sᵥ(n) and horizontally extended by Sₕ(n) from an N^{th} original frame. In this case, the Sᵥ(n) is indicative of the vertical shift information of the N^{th} frame, and Sₕ(n) is indicative of the horizontal shift information of the N^{th} frame.

In this case, the vertical shift information of the N^{th} frame and the horizontal shift information of the N^{th} frame may be randomly determined and may have the same value or different values.

Furthermore, an (N+1)^{th} extended frame has been vertically extended by Sᵥ(n+1) and horizontally extended by Sₕ(n+1) from an (N+1)^{th} original frame. In this case, the Sᵥ(n+1) is indicative of the vertical shift information of the (N+1)^{th} N^{th} frame, and the Sₕ(n+1) is indicative of the horizontal shift information of the (N+1)^{th} frame.

Likewise, the vertical shift information of the (N+1)^{th} frame and the horizontal shift information of the (N+1)^{th} frame may be randomly determined and may have the same value or different values.

Furthermore, the vertical and horizontal shift information of the N^{th} frame and the vertical and horizontal shift information of the (N+1)^{th} frame may have the same value or different values according to circumstances because they are randomly determined.

Furthermore, a region cropped from the N^{th} extended frame may be defined as an N^{th} target frame, and a region cropped from the (N+1)^{th} extended frame may be defined as an (N+1)^{th} target frame.

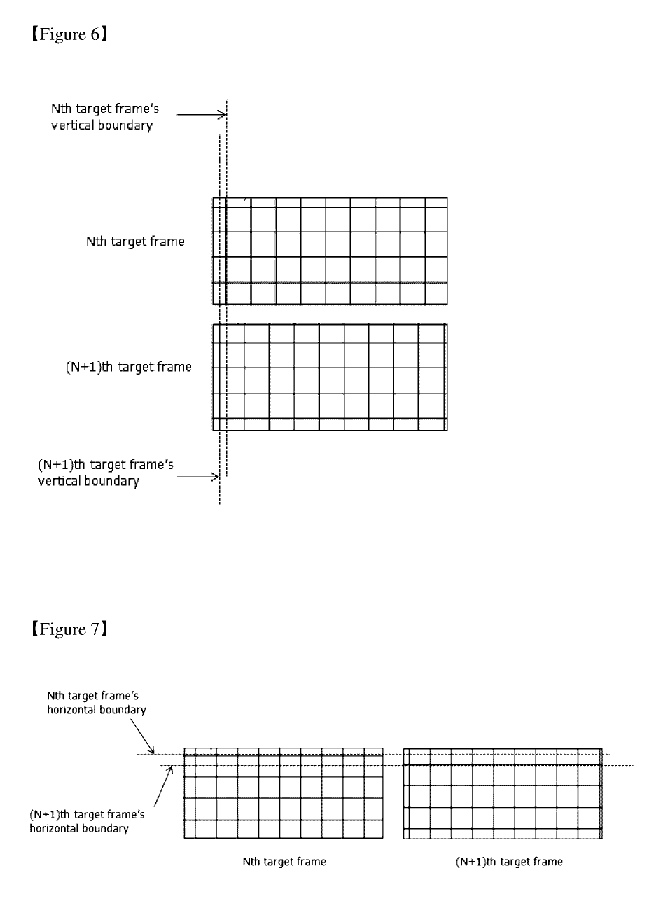

FIGS. 6 and 7 illustrate block structures for performing a comparison between the vertical and horizontal block boundaries of extended frames based on different pieces of random shift information in accordance with embodiments to which the present invention is applied.

FIG. 6 illustrates the block structures and vertical block boundaries of an N^{th} target frame cropped from an N^{th} extended frame and an (N+1)^{th} target frame cropped from an (N+1)^{th} extended frame.

A first dotted line from the left is indicative of the vertical block boundary of the N^{th} target frame, and a second dotted line from the left is indicative of the vertical block boundary of the N^{th} target frame.

That is, it may be seen that output target frames have different vertical block boundaries by applying different pieces of random shift information.

FIG. 7 illustrates the block structures and horizontal block boundaries of an N^{th} target frame cropped from an N^{th} extended frame and an (N+1)^{th} target frame cropped from an (N+1)^{th} extended frame.

A first dotted line from the top is indicative of the horizontal block boundary of the N^{th} target frame, and a second dotted line from the top is indicative of the horizontal block boundary of the N^{th} target frame.

That is, it may be seen that output target frames have different horizontal block boundaries by applying different pieces of random shift information.

Accordingly, the visibility of blocking artifacts can be reduced by consecutively outputting target frames having different block boundaries as described above.

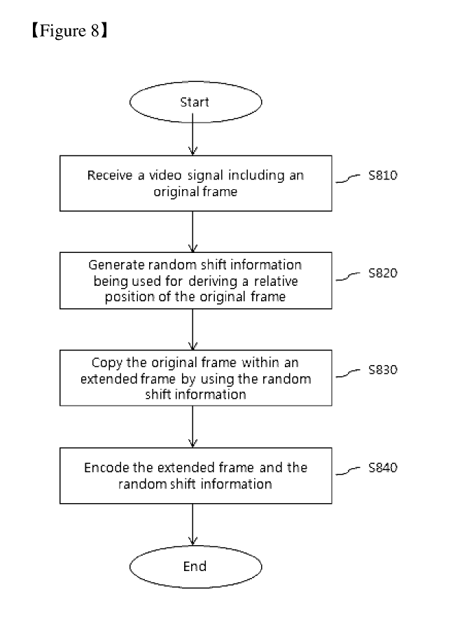

FIG. 8 is a flowchart illustrating a process of processing a video signal using random shift information in accordance with an embodiment to which the present invention is applied.

The video signal processing apparatus may receive a video signal including the original frame at step S810. The video signal processing apparatus may extend the original frame in order to improve coding efficiency. In this case, the video signal processing apparatus may generate random shift information used to derive the relative position of the original frame from an extended frame at step S820. In this case, the random shift information may include at least one of vertical shift information and horizontal shift information. Furthermore, the random shift information may be included in at least one of a sequence parameter, a picture parameter, a slice header, and Supplemental Enhancement Information (SEI).

The video signal processing apparatus may copy the original frame within the extended frame using the random shift information at step S830.

The video signal processing apparatus may generate a bit stream by encoding the extended frame and the random shift information at step S840. The generated bit stream may be transmitted to another apparatus.

In another embodiment, the random shift information may be directly transmitted from the frame extension unit 101 of FIG. 1 to the decoder 200 or the frame processing unit 201 of FIG. 2 without being decoded.

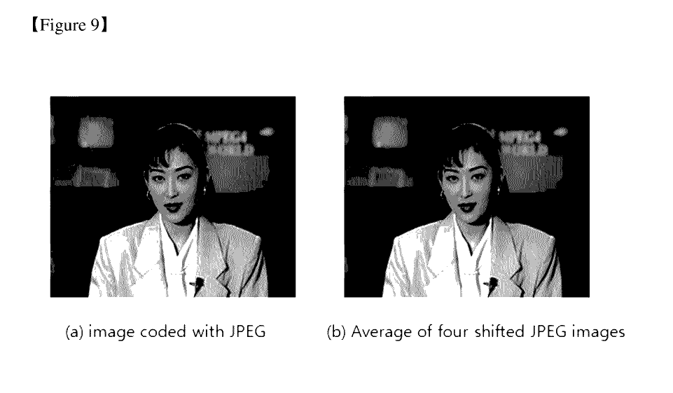

FIG. 9 illustrates test images for comparing an image (a) coded using an existing method with an image (b) to which an embodiment of the present invention has been applied.

FIG. 9(a) illustrates an image coded using an existing method, and FIG. 9(b) illustrates an image to which an embodiment of the present invention has been applied. FIG. 9(b) illustrates that four JPEG-coded images have been shifted using random shift information and averaged.

From a comparison between FIG. 9(a) and FIG. 9(b), it may be seen that picture quality of FIG. 9(b) is better than that of FIG. 9(a).

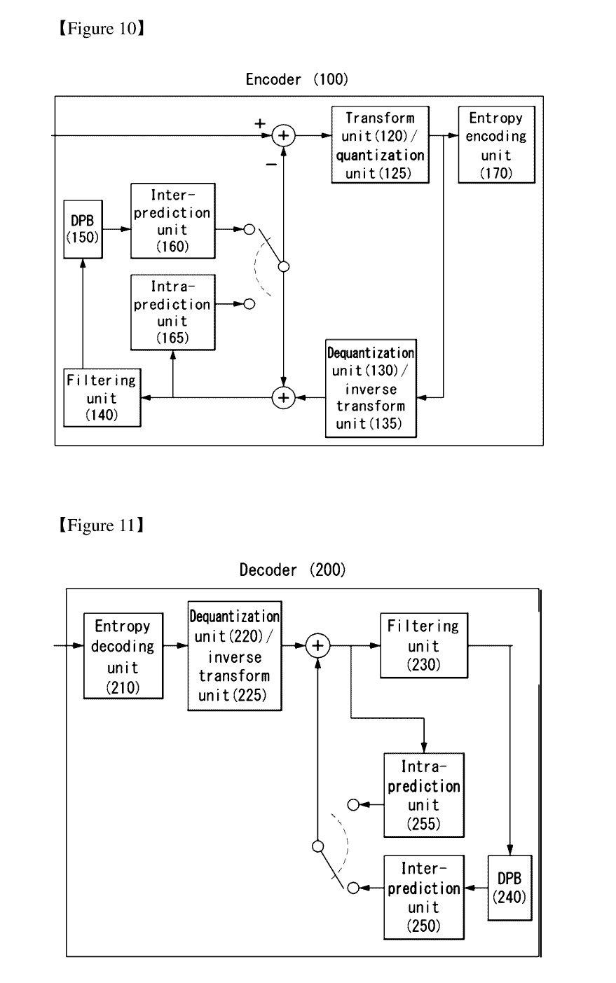

FIGS. 10 to 13 are schematic block diagrams of an encoder and a decoder for processing a video signal based on an extended frame using random shift information in accordance with embodiments to which the present invention is applied.

The present invention may be applied to a unit of the encoder and the decoder that requires shift information in a process of encoding or decoding a video signal.

FIG. 10 is a schematic block diagram of an encoder in which encoding is performed on a video signal in accordance with an embodiment to which the present invention is applied.

Referring to FIG. 10, the encoder 100 includes a transform unit 120, a quantization unit 125, a dequantization unit 130, an inverse transform unit 135, a filtering unit 140, a Decoded Picture Buffer (DPB) unit 150, an inter-prediction unit 160, an intra-prediction unit 165, and an entropy encoding unit 170.

The encoder 100 receives an video signal and generates a residual signal by subtracting a prediction signal, output by the inter-prediction unit 160 or the intra-prediction unit 165, from the input video signal. In this case, the video signal includes an extended frame, and the extended frame has been extended by shift information from an original video signal.

The generated residual signal is sent to the transform unit 120, and the transform unit 120 generates a transform coefficient by applying a transform scheme to the residual signal.

The quantization unit 125 quantizes the generated transform coefficient and sends the quantized coefficient to the entropy encoding unit 170. The entropy encoding unit 170 performs entropy coding on the quantized signal and outputs the resulting signal.

In such a compression process, an artifact in which a block boundary appears may occur because neighboring blocks are quantized by different quantization parameters. Such a phenomenon is called a blocking artifact, which is one of factors that may be used for people to evaluate picture quality.

The filtering unit 140 applies filtering to the reconstructed signal and outputs the filtered signal to a playback device or sends the filtered signal to the DPB unit 150.

The DPB unit 150 may store the filtered frame in order to use the filtered frame as a reference frame in the inter-prediction unit 160.

The inter-prediction unit 160 performs temporal prediction and/or spatial prediction with reference to a reconstructed picture in order to remove temporal redundancy and/or spatial redundancy. In this case, a reference picture used to perform prediction may include a blocking artifact or a ringing artifact because it is a signal that has been quantized or dequantized in a block unit when the reference picture is previously coded or decoded.

The intra-prediction unit 165 predicts a current block with reference to samples that neighbor a block to be now coded.

FIG. 11 illustrates a schematic block diagram of a decoder configured to decode a video signal in an embodiment to which the present invention is applied.

The decoder 200 of FIG. 11 includes an entropy decoding unit 210, a dequantization unit 220, an inverse transform unit 225, a filtering unit 230, a DPB unit 240, an inter-prediction unit 250, and an intra-prediction unit 255.

The decoder 200 receives a signal output by the encoder 100 of FIG. 10. In this case, the output signal may include an extended frame, and may additionally include shift information.

The received signal is subjected to entropy decoding through the entropy decoding unit 210. The dequantization unit 220 obtains a transform coefficient from the entropy-decoded signal using information about a quantization step size. The inverse transform unit 225 obtains a difference signal by inversely transforming the transform coefficient. A reconstructed signal is generated by adding the obtained difference signal to a prediction signal output by the inter-prediction unit 250 or the intra-prediction unit 255.

The filtering unit 230 applies filtering to the reconstructed signal and outputs the filtered signal to a playback device or the DPB unit 240. The filtered signal transmitted by the DPB unit 240 may be used as a reference frame in the inter-prediction unit 250.

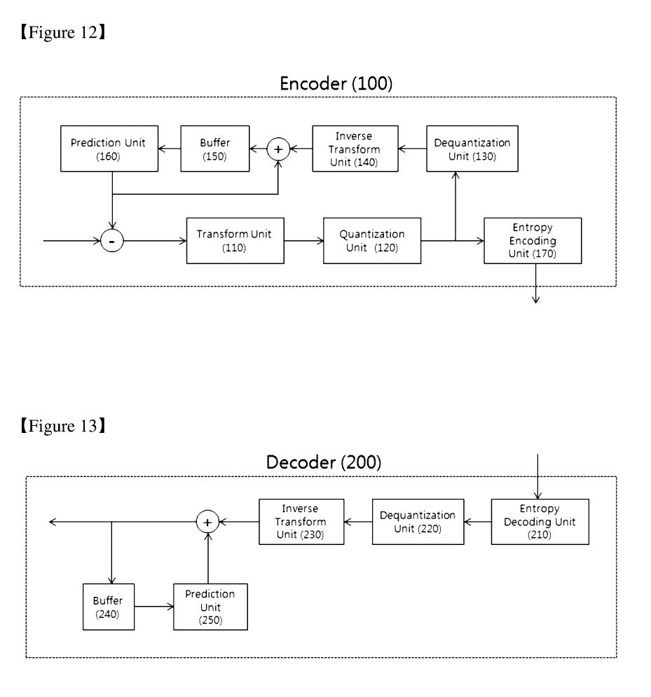

FIGS. 12 and 13 illustrate schematic block diagrams of an encoder and a decoder to which an embodiment of the present invention has been applied.

The encoder 100 of FIG. 12 includes a transform unit 110, a quantization unit 120, a dequantization unit 130, an inverse transform unit 140, a buffer 150, a prediction unit 160, and an entropy encoding unit 170. The decoder 200 of FIG. 13 includes an entropy decoding unit 210, a dequantization unit 220, an inverse transform unit 230, a buffer 240, and a prediction unit 250.

The encoder 100 receives a video signal and generates a prediction error by subtracting a predicted signal, output by the prediction unit 160, from the video signal. In this case, the video signal includes an extended frame, and the extended frame has been extended by shift information from an original video signal.

The generated prediction error is transmitted to the transform unit 110. The transform unit 110 generates a transform coefficient by applying a transform scheme to the prediction error.

The quantization unit 120 quantizes the generated transform coefficient and sends the quantized coefficient to the entropy encoding unit 170.

The entropy encoding unit 170 performs entropy coding on the quantized signal and outputs an entropy-coded signal.

Meanwhile, the quantized signal output by the quantization unit 120 may be used to generate a prediction signal. For example, the dequantization unit 130 and the inverse transform unit 140 within the loop of the encoder 100 may perform dequantization and inverse transform on the quantized signal so that the quantized signal is reconstructed into a prediction error. A reconstructed signal may be generated by adding the reconstructed prediction error to a prediction signal output by the prediction unit 160.

The buffer 150 stores the reconstructed signal for the future reference of the prediction unit 160. The prediction unit 160 generates a prediction signal using a previously reconstructed signal stored in the buffer 150.

The decoder 200 of FIG. 13 receives a signal output by the encoder 100 of FIG. 12. In this case, the output signal may include an extended frame, and may additionally include shift information.

The entropy decoding unit 210 performs entropy decoding on the received signal. The dequantization unit 220 obtains a transform coefficient from the entropy-decoded signal based on information about a quantization step size. The inverse transform unit 230 obtains a prediction error by performing inverse transform on the transform coefficient. A reconstructed signal is generated by adding the obtained prediction error to a prediction signal output by the prediction unit 250.

The buffer 240 stores the reconstructed signal for the future reference of the prediction unit 250. The prediction unit 250 generates a prediction signal using a previously reconstructed signal stored in the buffer 240.

In accordance with the present invention, the visibility of blocking artifacts can be reduced by encoding and decoding the extended frame and shift information. Furthermore, the subjective picture quality of a video signal can be improved by reducing the visibility of blocking artifacts.

As described above, a processing apparatus including the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional (3D) video apparatus, a teleconference video apparatus, and a medical video apparatus and may be used to process video signals and data signals.

Furthermore, the processing method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves (e.g., transmission through the Internet). Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1. A method of processing a video signal, comprising:
receiving a video signal comprising an original frame;
generating random shift information being used to derive a relative position of the original frame;
copying the original frame within an extended frame using the generated random shift information; and
encoding the extended frame and the random shift information,
wherein a boundary of frames included in the video signal varies for each frame based on the random shift information.

2. The method of claim 1, wherein the random shift information is generated horizontally and/or vertically for each frame.

3. The method of claim 1, wherein the extended frame is extended by one block size or more in each dimension of the original frame.

4. The method of claim 1, wherein the random shift information is inserted in a slice header.

5. A method of processing a video signal, comprising:
receiving the video signal comprising an extended frame and random shift information;
decoding the extended frame comprising a target frame and the random shift information; and
outputting the extended frame and the random shift information,
wherein the target frame indicates a frame with an original frame size which is cropped from the extended frame based on the random shift information.

6. The method of claim 5, wherein the random shift information is used to derive a position of the target frame horizontally and/or vertically.

7. The method of claim 5, wherein the extended frame has been extended by one block size or more in each dimension of the target frame.

8. The method of claim 5, wherein the random shift information is extracted from a slice header of the video signal.

9. An apparatus for processing a video signal, comprising:
a frame extension unit configured to receive a video signal comprising an original frame, generate random shift information being used to derive a relative position of the original frame, and copy the original frame within an extended frame using the generated random shift information; and
an encoder configured to encode the extended frame and the random shift information,
wherein a boundary of frames included in the video signal varies for each frame based on the random shift information.

10. The apparatus of claim 9, wherein the random shift information is generated horizontally and/or vertically for each frame.

11. The apparatus of claim 9, wherein the extended frame is extended by one block size or more in each dimension of the original frame.

12. The apparatus of claim 9, wherein the random shift information is inserted in a slice header.

13. A decoder for decoding a video signal, wherein:
the decoder configured to:
receive the video signal comprising an extended frame and random shift information,
decode the extended frame comprising a target frame and the random shift information, and
output the extended frame and the random shift information,
wherein the target frame indicates a frame with an original frame size which is cropped from the extended frame based on the random shift information.

14. The decoder of claim 13, wherein the random shift information is used to derive a position of the target frame horizontally and/or vertically.

15. The decoder of claim 13, wherein the extended frame has been extended by one block size or more in each dimension of the target frame.

16. The decoder of claim 13, wherein the random shift information is extracted from a slice header of the video signal.
